(19) United States
(12) Patent Application Publication
(10) Pub. No.: US 2009/0242855 A1
(43) Pub. Date: Oct. 1, 2009

(54) VOLTAGE SWITCHABLE DIELECTRIC MATERIALS WITH LOW BAND GAP POLYMER BINDER OR COMPOSITE

(76) Inventors: Robert Fleming, San Jose, CA (US); Lex Kosowsky, San Jose, CA (US); Ning Shi, San Jose, CA (US); Junjun Wu, Woodbury, MN (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 12/407,346

(22) Filed: Mar. 19, 2009

Related U.S. Application Data
(60) Provisional application No. 61/039,782, filed on Mar. 26, 2008.

(51) Int. Cl. H01B 1/24; C08L 63/00; H01B 1/20

(52) U.S. Cl. 252/519.34; 252/500; 252/519.33; 525/118

(57) ABSTRACT

A composition is provided that includes a polymer binder, and one or more classes of particle constituents. At least one class of particle constituents includes semiconductive particles that individually have a band gap that is no greater than 2 eV. As VSD material, the composition is (i) dielectric in absence of a voltage that exceeds a characteristic voltage level, and (ii) conductive with application of said voltage that exceeds the characteristic voltage level.

### RELATED APPLICATIONS

This Application claims benefit of priority to Provisional U.S. Patent Application No. 61/039,782, filed Mar. 26, 2008; the aforementioned priority application being hereby incorporated by reference in its entirety.

### FIELD

Embodiments described herein pertain to voltage switchable dielectric material. In particular, embodiments described herein pertain to voltage switchable dielectric materials with low band fap polymer binder or composite.

### BACKGROUND

Voltage switchable dielectric (VSD) materials are known to be materials that are insulative at low voltages and conductive at higher voltages. These materials are typically composites comprising of conductive, semiconductive, and insulative particles in an insulative polymer matrix. These materials are used for transient protection of electronic devices, most notably electrostatic discharge protection (ESD) and electrical overstress (EOS). Generally, VSD material behaves as a dielectric, unless a characteristic voltage or voltage range is applied, in which case it behaves as a conductor. Various kinds of VSD material exist. Examples of voltage switchable dielectric materials are provided in references such as U.S. Pat. No. 4,977,357, U.S. Pat. No. 5,068,634, U.S. Pat. No. 5,099,380, U.S. Pat. No. 5,142,263, U.S. Pat. No. 5,189,387, U.S. Pat. No. 5,248,517, U.S. Pat. No. 5,807,509, WO 96/02924, and WO 97/26665, all of which are incorporated by reference herein.

VSD materials may be formed using various processes and materials or compositions. One conventional technique provides that a layer of polymer is filled with high levels of metal particles to very near the percolation threshold, typically more than 25% by volume. Semiconductor and/or insulator materials are then added to the mixture.

Another conventional technique provides for forming VSD material by mixing doped metal oxide powders, then sintering the powders to make particles with grain boundaries, and then adding the particles to a polymer matrix to above the percolation threshold.

Other techniques and compositions for forming VSD material are described in U.S. patent application Ser. No. 11/829,946, entitled VOLTAGE SWITCHABLE DIELECTRIC MATERIAL HAVING CONDUCTIVE OR SEMI-CONDUCTIVE ORGANIC MATERIAL; and U.S. patent application Ser. No. 11/829,948, entitled VOLTAGE SWITCHABLE DIELECTRIC MATERIAL HAVING HIGH ASPECT RATIO PARTICLES.

### BRIEF DESCRIPTION OF THE DRAWINGS

FIG. 1 is an illustrative (not to scale) sectional view of a layer or thickness of VSD material, depicting the constituents of VSD material in accordance with various embodiments.

FIG. 2 is a close-up of a random sample portion of the VSD material depicted in FIG. 1, to illustrate effects of using particle fillers that have relatively lower band gap in VSD material, according to an embodiment.

FIG. 3A and FIG. 3B each illustrate different configurations for a substrate device that is configured with VSD material having a composition such as described with any of the embodiments provided herein.

FIG. 4 is a simplified diagram of an electronic device on which VSD material in accordance with embodiments described herein may be provided.

### DESCRIPTION

Embodiments described herein provide for VSD material that includes a polymer binder with a relatively low band gap. The polymer binder may be formulated to have a band gap that is less than 2 electron volts (eV). In one embodiment, the polymer binder has a band gap value that is in range of 0.8 to 1.2 eV. The polymer binder may be formed from multiple polymer constituents, including at least one polymer constituent that is used to tune the effective band gap of the polymer binder to the desired range.

As an addition or alternative, embodiments described herein provide for VSD material that contains semiconductive particles with relatively low band gap to enhance polymer performance. Such semiconductive particles may correspond to micron or nanometer dimensioned particles that have band gaps that are substantially equal or comparable (e.g. less than 2 electron volts (eV)) to the band gap of the polymer binder. Such semiconductive particles may be dispersed in the polymer binder to form a polymer composite portion of the VSD material.

According to an embodiment, a composition is provided that includes one or more polymer constituents, and one or more classes of particle constituents. At least one class of particle constituents includes semiconductive particles that individually have a band gap that is no greater than 2 eV. As an alternative or addition, the semiconductive particles individually have a bandgap that is substantially equal to the band gap of the polymer binder. As VSD material, the composition is (i) dielectric in absence of a voltage that exceeds a characteristic voltage level, and (ii) conductive with application of said voltage that exceeds the characteristic voltage level.

Voltage Switchable Dielectric (VSD) Material

As used herein, “voltage switchable material” or “VSD material” is any composition, or combination of compositions, that has a characteristic of being dielectric or non-conductive, unless a field or voltage is applied to the material that exceeds a characteristic level of the material, in which case the material becomes conductive. Thus, VSD material is a dielectric unless voltage (or field) exceeding the characteristic level (e.g. such as provided by ESD events) is applied to the material, in which case the VSD material is switched into a conductive state. VSD material can further be characterized as a nonlinear resistance material. In many applications, the characteristic voltage of VSD material ranges in values that exceed the operational voltage levels of the circuit or device several times over. Such voltage levels may be of the order of transient conditions, such as produced by electrostatic discharge, although embodiments may include use of planned electrical events. Furthermore, one or more embodiments provide that in the absence of the voltage exceeding the characteristic voltage, the material behaves similar to the binder (i.e. it is non-conductive or dielectric).

Still further, an embodiment provides that VSD material may be characterized as material comprising a binder mixed in part with conductor or semi-conductor particles. In the absence of voltage exceeding a characteristic voltage level, the material as a whole adapts the dielectric characteristic of the binder. With application of voltage exceeding the characteristic level, the material as a whole adapts conductive characteristics.

According to embodiments described herein, the constituents of VSD material may be uniformly mixed into a binder or polymer matrix. In one embodiment, the mixture is dispersed at nanoscale, meaning the particles that comprise the conductive/semi-conductive material are nano-scale in at least one dimension (e.g. cross-section) and a substantial number of the particles that comprise the overall dispersed quantity in the volume are individually separated (so as to not be agglomerated or compacted together).

Still further, an electronic device may be provided with VSD material in accordance with any of the embodiments described herein. Such electrical devices may include substrate devices, such as printed circuit boards, semiconductor packages, discrete devices, thin-film electronics, Light Emitting Diodes (LEDs), radio-frequency (RF) components, and display devices.

Some compositions of VSD materials work by loading conductive and/or semiconductive materials into a polymer binder in an amount that is just below percolation. Percolation may correspond to a statistically defined threshold by which there is a continuous conduction path when a relatively low voltage is applied. Other materials insulative or semiconductive materials may be added to better control the percolation threshold.

Polymer Binder or Composite

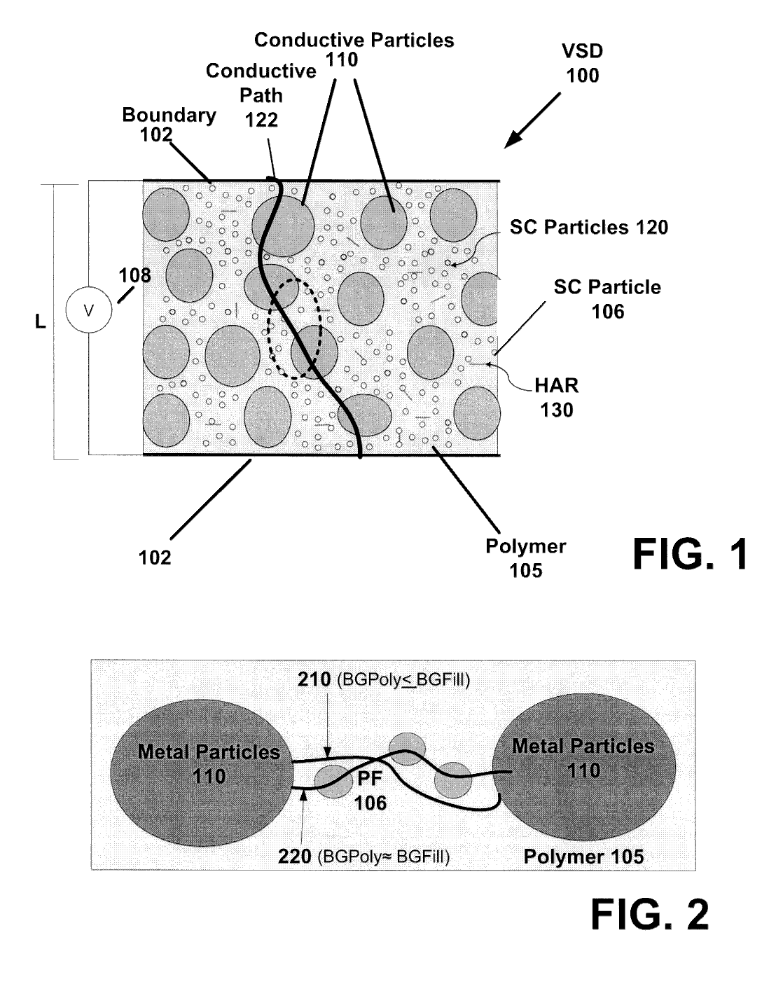

Some embodiments described herein use a blend of polymers as the polymer binder of VSD material, in order to lower or tune the effective band gap of the polymer binder. By lowering the effective band gap of the polymer binder, the “turn-on” voltage (i.e. clamp or trigger voltage) of the VSD material may be reduced. In an embodiment, the polymer binder may be tuned to have an effective band gap of a desired value. The polymer binder may be tuned by mixing select concentrations of polymers. The polymer blend may include a first type of polymer that has a relatively low band gap, and a second type of polymer that has other desirable characteristics or properties, such as, for example, desirable physical or mechanical properties. Mixing polymers forms a polymer binder that has an effective band gap that is of a desired value. Lower effective band gaps for the polymer binder facilitates reduction in trigger/clamp voltage of the VSD material, while at the same maintaining desirable mechanical properties in the VSD material. Specific examples of binders and polymers for use in polymer binders is described with an embodiment of FIG. 1.

More specifically, electron transport in disordered amorphous phase via localized states significantly differs from that of electron transport in ordered crystalline phase. The disordered amorphous phase of polymer induces randomly distributed localized states in the energy band. Embodiments further recognize that the electron transitions between localized states with energies in the vicinity of the Fermi level are most efficient for transport. The effective band gap for polyethylene and epoxy is around 0.9 eV and 0.8 eV, respectively. Different bonding structure also induced localized energy states near the Fermi level, for example, an in-chain conjugated carbon-carbon double bond in polyethylene induces an electron trap with depth of 0.51 ev and a hole trap with a depth of 1.35 eV near the Fermi level. The localized states generated by conjugated bonding structures results in a smaller effective band gap for conjugated polymers. Furthermore, the effective band gap of a polymer can be tailored by introducing suitable bonding structure with reasonable energy level. Thus, under this approach, the band gap of the binder or polymer matrix can be tuned.

As an addition or alternative, some embodiments incorporate semiconductive particles into the polymer binder that individually have a relatively low band gap (i.e. less than 2 eV). Semiconductive particles in polymer or polymer binder is said to form polymer composite. In one embodiment, the semiconductive particles are selected so that the band gap of the particles is substantially equal to (or even less than) the effective band gap of the (polymer) binder. The use of semiconductive particles in this manner enhances the physical properties of the VSD material.

Embodiments recognize that conventional VSD materials (such as referenced above) have an inherent issue relating to the properties of the material after being pulsed. Specifically, VSD material that is pulsed with a high voltage event (such as by ESD or simulated version thereof) must allow for some current to flow through the polymer matrix between adjacent conductive particles. It is believed that side reactions typically result which limit conduction, and cause a hysteresis between the off state resistance before the high voltage event and after the high voltage event. This hysteresis is due to degradation of the polymer that result as a byproduct of conduction. Embodiments further recognize that degradation of polymer may be reduced by formulating the VSD material to include polymer composite that has micron or nanometer sized semiconductive particles with band gap values that are comparable (or substantially equal to) the band gap of the polymer binder. Such semiconductive particles may be loaded into the polymer binder as fillers, and are tuned to the band gap of the polymer binder in order to improve the physical properties of the polymer binder after the VSD material is subjected to an initial pulse (e.g. ESD or EOS event). By improving the properties of the polymer composite, embodiments provide for VSD composition that has superior characteristics, including improved leakage current and durability. More particularly, after an initial pulse, in which the VSD material is switched on (or stressed), polymer degradation is reduced or avoided, thereby reducing or eliminating problems such as an increase in leakage current or degradation after the initial pulse. Additionally, by using a low band gap polymer composite or matrix, the trigger or clamp voltage of the VSD material may be reduced.

In some embodiments, the “effective band gap” of polymer binders for VSD material is generally close to approximately 1 eV (electron volt). The effective band gap, described by the energy separation between the bottom of the conduction band and the top of the valence band, is the basic physical characteristic controlling the electron transport in the polymer composite.

Accordingly, some embodiments described herein recognize benefits of using semiconductive particles dispersed in the polymer or binder that have a band gap that substantially matches the band gap of the binder or polymer binder. As used herein, the band gap of the semiconductive particles is said to substantially match that of the polymer if the average of the two values is within 30% of each respective value. In some embodiments, the semiconductive particles have band gaps that are approximately 1 eV. As mentioned, the exact band gap of either the polymer, or the semiconductive particles, may be selected such that resulting VSD material has both (i) a low voltage (as applied, less than 50 volts, more preferably less than 12 volts) resistance value that is high (e.g. >10 Mohms), an (ii) on-state resistance value that is low, <10 kohms.

Various types of particles may be used as low band gap semiconductive particles that are dispersed in polymer binder to form polymer composite. As described with embodiments, semiconductive particles may include semiconductor particles, including compound semiconductive particles, that are selected or modified by size, shape and/or compounds to have a desired band gap value.

VSD Material with Polymer Binder/Composite

FIG. 1 is an illustrative (not to scale) sectional view of a layer or thickness of VSD material, depicting the constituents of VSD material in accordance with various embodiments. As depicted, VSD material 100 includes polymer binder 105 and a concentration of low band gap semiconductive particles 106. The semiconductive particles 106 may be micron or nanometer in dimension, and loaded into the polymer binder 105 to form the polymer composite of the VSD material. In addition to semiconductive particles 106, other particle constituents may include metal particles 110, semiconductor particles 120 (optionally, if different than the semiconductive particles 106), and high-aspect ratio (HAR) particles 130 (if different than the semiconductive particles 106). Descriptions of the different types of particles that can correspond to the semiconductive particles 106 are provided below. It should be noted that the type of particle constituent that are included in the VSD composition may vary, depending on the desired electrical and physical characteristics of the VSD material. For example, some VSD compositions may include metal particles 110, but not semiconductive particles 120 and/or HAR particles 130. Still further, other embodiments may omit use of conductive particles 110.

Examples for polymer binder 105 include polyethylenes, silicones, acrylates, polymides, polyurethanes, epoxies, and copolymers, and/or blends thereof. In one embodiment, the polymer binder 105 corresponds to epoxy blended with a low band gap polymer, such as an acrylate, so as to tune the polymer binder 105 to have a desired band gap value. In another embodiment, the polymer binder 105 corresponds to hexanedioldiacrylate blended with bisphenol A epoxy.

Examples of conductive materials 110 include metals such as copper, aluminum, nickel, silver, gold, titanium, stainless steel, chrome, other metal alloys, or conductive ceramics like titanium diboride. Examples of semiconductive material 120 include both organic and inorganic semiconductors. Some inorganic semiconductors include, silicon carbide, boron nitride, aluminum nitride, nickel oxide, zinc oxide, zinc sulfide, bismuth oxide, titanium dioxide, cerium oxide, and iron oxide. The specific formulation and composition may be selected for mechanical and electrical properties that best suit the particular application of the VSD material. The HAR particles 130 may be organic (e.g. carbon nanotubes, graphene) or inorganic (e.g. nano-wires or nanorods), and may be dispersed between the other particles at various concentrations. More specific examples of HAR particles 130 may correspond to conductive or semi-conductive inorganic particles, such as provided by nanowires or certain types of nanorods. Material for such particles include copper, nickel, gold, silver, cobalt, zinc oxide, tin oxide, silicon carbide, gallium arsenide, aluminum oxide, aluminum nitride, titanium dioxide, antimony, boron nitride, tin oxide, indium tin oxide, indium zinc oxide, bismuth oxide, cerium oxide, and antimony zinc oxide.

The dispersion of the various classes of particles in the polymer 105 may be such that the VSD material 100 is non-layered and uniform in its composition, while exhibiting electrical characteristics of voltage switchable dielectric material. Generally, the characteristic voltage of VSD material is measured at volts/length (e.g. per 5 mil), although other field measurements may be used as an alternative to voltage. Accordingly, a voltage 108 applied across the boundaries 102 of the VSD material layer may switch the VSD material 100 into a conductive state if the voltage exceeds the characteristic voltage for the gap distance L. In the conductive state, the polymer composite (comprising polymer binder 105 and semiconductive particles 106) conducts charge (as depicted by conductive path 122) between the conductive particles 110, from one boundary of VSD material to the other. One or more embodiments provide that VSD material has a characteristic voltage level that exceeds that of an operating circuit. As mentioned, other characteristic field measurements may be used.

According to one or more embodiments, the semiconductive particles 106 may correspond to compound semiconductors that are selected, modified, or dimensioned to have a band gap that is comparable or substantially equal to that of the polymer binder 105. In one embodiment, the polymer binder 105 has a band gap in the range of 0.8-1.2 eV, and the semiconductive particles 106 are selected, modified and/or dimensioned to have a band gap that is about in the same range.

Some embodiments provide for use of semiconductors as semiconductive particles 106. Examples of semiconductors that can be used as fillers include silicon, germanium, and more recently compound semiconductors of the type III-V, InAs, InSb, GaSb, II-VI, III-VI and I-III-VI such as In₂Se₃ (IS), CuInSe₂ (CIS), CuGaSe₂, CuInS2 and CuInₓGa₁₋ₓSe₂ (CIGS). An embodiment provides that the semiconductive particles 106 includes or corresponds to CuInxGa1-xSe2, which both low band gap and unique grain boundaries between crystallites of a polycrystalline film. The grain boundaries are proposed to have unique hole energy barrier properties and randomly distributed p-n junctions in the polycrystalline structures. Such properties of silicon, germanium, or III-VI, II-VI, and I-III-VI compound semiconductors also enables composites of these materials to have desirable voltage switchable or non-linear resistive properties.

Compound semiconductor devices are typically synthesized from costly vacuum-based deposition methods. In order to lower the manufacturing costs of transistors and photovoltaic devices silicon, a number of non-vacuum methods have been developed to synthesize CIS, CIGS, and other compound semiconductor devices. Some of these non-vacuum methods include synthesizing silicon, CIS, and CIGS micron sized particles, nanoparticles, or Quantum Dots that can then later be dispersed in a polymer resin.

Particles that are so small that they become quantum confined are referred to as “Quantum Dots”. In an embodiment, the semiconductive particles 106 include or correspond to Quantum Dot (QD) semiconductors such as PbS, PbSe, PbTe, CdS, CdSe, CdTe, and GaN. QD semiconductors have relatively low band gaps that are partly a function of semiconductor type and size.

According to some embodiments, VSD material may be comprised of (i) conductive particles, and (ii) compound semiconductive particles (which may be provided as semiconductive particles 106). Optionally, other semiconductors (such as the conventional metal oxide type), HAR particles, and/or insulative particles may also be incorporated. The compound semiconductive particles may be “micron sized”, “nanometer sized”. More preferably, compound semiconductors are chosen (as semiconductive particles 106) that have a band gap of <2 eV, and most preferably have an effective band gap of <1.5 eV.

Table 1 provides the band gaps of selected semiconductors materials. Given that the effective bandgap of polymer binder 105 that is on the order of 1 eV (or less than 2 eV), it is most desirable that semiconductive particles 106 are selected that have a band gap close to or less than about 1 eV in order to minimize space charge buildup or degredative side reactions in the polymer. Thus, in Table 1, CuInS2, CuInSe2, GaAs, InP, Si, PbSe, PbS, and PbTe are suited for use with or as semiconductive particles 106. Optionally, compounds in table 1 can be doped to lower the effective band gap of the particle. For example silicon can be doped with small amounts of boron or phosphorus atoms to increase the current mobility and decrease the effective band gap.

TABLE 1

| Material (Symbol) | Band gap (eV) |
|---|---|
| Bismuth telluride (Bi2Te3) | 0.16 |
| Indium antimonide (InSb) | 0.17-0.75 |
| Indium nitride (InN) | 0.17-1.89 |
| Lead(II) selenide (PbSe) | 0.27-0.91 |
| Lead(II) telluride (PbTe) | 0.29-0.73 |
| Lead(II) sulfide (PbS) | 0.37-0.8 |
| Indium(III) arsenide (InAs) | 0.36 |
| Germanium (Ge) | 0.67 |
| Gallium antimonide (GaSb) | 0.72-0.75 |
| Copper Indium Selenide (CuInSe2) | 0.9 |
| Silicon germanide (SiGe) | 0.9 |
| Silver Sulfide (AgS) | 1.0-2.2 |
| Silicon (Si) | 1.11 |
| Copper Indium Sulfide (CuInS2) | 1.2 |
| Indium(III) phosphide (InP) | 1.35 |
| Gallium(III) arsenide (GaAs) | 1.43 |
| Boron arsenide (BAs) | 1.46 |
| Cadmium telluride (CdTe) | 1.47-1.56 |
| Aluminium antimonide (AlSb) | 1.58-1.62 |
| Cadmium selenide (CdSe) | 1.71-1.73 |
| Gallium Selenide (GaSe) | 1.97 |
| Boron phosphide (BP) | 2.0 |
| Aluminium arsenide (AlAs) | 2.15-2.16 |
| Tin sulfide (SnS) | 2.2 |
| Zinc telluride (ZnTe) | 2.25-2.39 |
| Gallium(III) phosphide (GaP) | 2.27 |
| Cadmium sulfide (CdS) | 2.42-2.5 |
| Aluminum phosphide (AlP) | 2.45 |
| Copper Aluminum Sulfide (CuAlS2) | 2.5 |
| Gallium(II) sulfide (GaS) | 2.5 |
| Gallium(III) nitride (GaN) | 2.67-3.5 |
| Zinc selenide (ZnSe) | 2.7-2.82 |
| Silicon carbide (SiC) | 2.86-3.0 |
| Zinc oxide (ZnO) | 3.37 |
| Cuprous chloride (CuCl) | 3.4 |
| Zinc sulfide (ZnS) | 3.68-3.91 |

FIG. 2 is a close-up (not to scale) and illustrative representation of a random sample portion of the VSD material depicted in FIG. 1, to illustrate effects of using semiconductive particles 106 that have relatively lower band gap in VSD material, according to an embodiment. In FIG. 2, the sample includes conductive particles 110 separated by polymer binder 105 and semiconductive particles 106. For VSD material to switch into the conductive state, a path forms between two adjacent particles 110 (such as shown). When semiconductive particles 106 have relatively higher band gaps than the polymer binder 105, the conductive path between the conductive particles 110 avoids the semiconductive particles (i.e. path of least resistance), so as to follow a path of least electrical resistance. This is illustrated by conductive path 210 (BGPoly≦BGFill).

On the other hand, if the semiconductive particles 106 have substantially equal band gap values as the polymer binder 105, charge between two adjacent conductive particles 110 is more likely to pass through semiconductive particles 106. This is illustrated by particle conductive path 220 (BGPoly≈BGFill). Embodiments such as described provide for VSD composition, through use of polymer binder 105 and low band gap semiconductive particles 106, to promote or increase use of conductive paths depicted by the conductive path 220. The increase use of particles in polymer composite reduce overall degradation of polymer binder 105, resulting in, for example, improved leakage current, particular after the VSD material has been pulsed.

Variations and Alternatives

While some embodiments described herein provide for identifying and selecting semiconductive particles 106 with suitable band gaps (i.e. substantially equal to that of the polymer binder 105), other embodiments provide for designing, configuring or forming the semiconductive particle to have the desired band gap. Still, some types of semiconductive particles may be shaped to affect the band gap of the particle (and thus to make it more or less in range to that of the desired value). For example, the semiconductive particles 106 may include or correspond to compound semiconductors, silicon, germanium, or QD particles that are shaped to be non-spherical (e.g. cubes, prisms, tetrahedrons), have legs (e.g. tetrapods), or rods. These physical characteristics can also affect the characteristic band gap of the particle, and can be used to tune the filler particles up or down in the desired band gap range.

VSD Material Applications

Numerous applications exist for compositions of VSD material in accordance with any of the embodiments described herein. In particular, embodiments provide for VSD material to be provided on substrate devices, such as printed circuit boards, semiconductor packages, discrete devices, thin film electronics, as well as more specific applications such as LEDs and radio-frequency devices (e.g. RFID tags). Still further, other applications may provide for use of VSD material such as described herein with a liquid crystal display, organic light emissive display, electrochromic display, electrophoretic display, or back plane driver for such devices. The purpose for including the VSD material may be to enhance handling of transient and overvoltage conditions, such as may arise with ESD events. Another application for VSD material includes metal deposition, as described in U.S. Pat. No. 6,797,145 to L. Kosowsky (which is hereby incorporated by reference in its entirety).

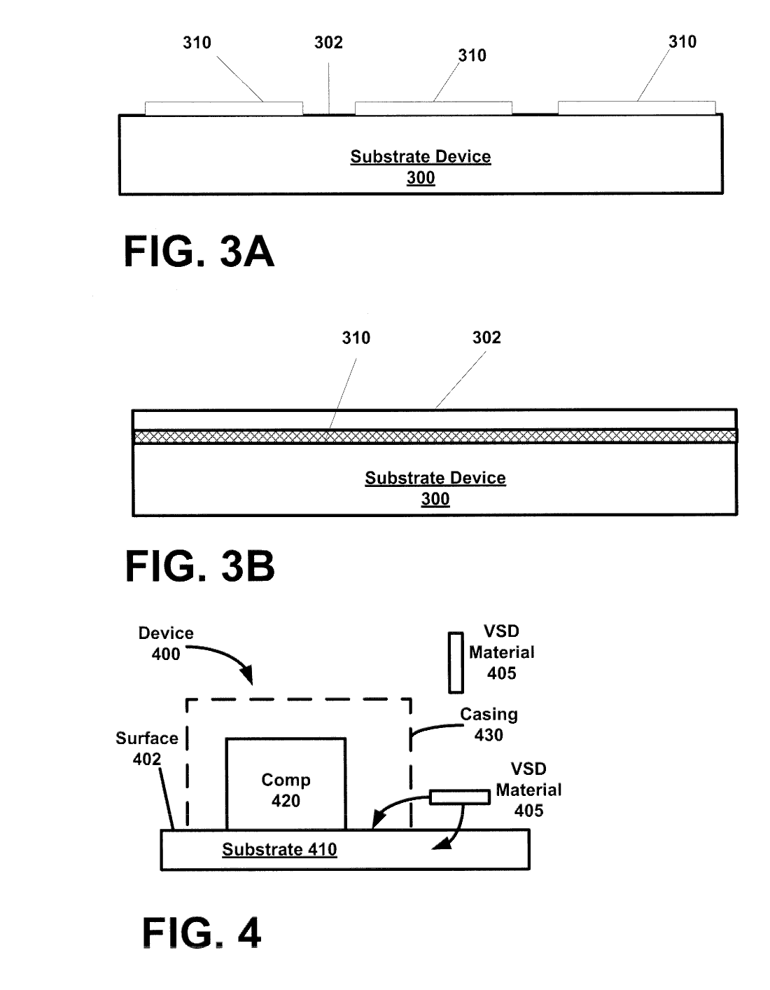

FIG. 3A and FIG. 3B each illustrate different configurations for a substrate device that is configured with VSD material having a composition such as described with any of the embodiments provided herein. In FIG. 3A, the substrate device 300 corresponds to, for example, a printed circuit board. In such a configuration, VSD material 310 (having a composition such as described with any of the embodiments described herein) may be provided on a surface 302 to ground a connected element. As an alternative or variation, FIG. 3B illustrates a configuration in which the VSD material forms a grounding path that is embedded within a thickness 310 of the substrate.

Electroplating

In addition to inclusion of the VSD material on devices for handling, for example, ESD events, one or more embodiments contemplate use of VSD material (using compositions such as described with any of the embodiments herein) to form substrate devices, including trace elements on substrates, and interconnect elements such as vias. U.S. patent application Ser. No. 11/881,896, filed on Sep. Jul. 29, 2007, and which claims benefit of priority to U.S. Pat. No. 6,797,145 (both of which are incorporated herein by reference in their respective entirety) recites numerous techniques for electroplating substrates, vias and other devices using VSD material. Embodiments described herein enable use of VSD material, as described with any of the embodiments in this application.

Other Applications

FIG. 4 is a simplified diagram of an electronic device on which VSD material in accordance with embodiments described herein may be provided. FIG. 4 illustrates a device 400 including substrate 410, component 420, and optionally casing or housing 430. VSD material 405 (in accordance with any of the embodiments described) may be incorporated into any one or more of many locations, including at a location on a surface 402, underneath the surface 402 (such as under its trace elements or under component 420), or within a thickness of substrate 410. Alternatively, the VSD material may be incorporated into the casing 430. In each case, the VSD material 405 may be incorporated so as to couple with conductive elements, such as trace leads, when voltage exceeding the characteristic voltage is present. Thus, the VSD material 405 is a conductive element in the presence of a specific voltage condition.

With respect to any of the applications described herein, device 500 may be a display device. For example, component 420 may correspond to an LED that illuminates from the substrate 410. The positioning and configuration of the VSD material 405 on substrate 410 may be selective to accommodate the electrical leads, terminals (i.e. input or outputs) and other conductive elements that are provided with, used by or incorporated into the light-emitting device. As an alternative, the VSD material may be incorporated between the positive and negative leads of the LED device, apart from a substrate. Still further, one or more embodiments provide for use of organic LEDs, in which case VSD material may be provided, for example, underneath the OLED.

With regard to LEDs and other light emitting devices, any of the embodiments described in U.S. patent application Ser. No. 11/562,289 (which is incorporated by reference herein) may be implemented with VSD material such as described with other embodiments of this application.

Alternatively, the device 400 may correspond to a wireless communication device, such as a radio-frequency identification device. With regard to wireless communication devices such as radio-frequency identification devices (RFID) and wireless communication components, VSD material may protect the component 420 from, for example, overcharge or ESD events. In such cases, component 420 may correspond to a chip or wireless communication component of the device. Alternatively, the use of VSD material 405 may protect other components from charge that may be caused by the component 420. For example, component 420 may correspond to a battery, and the VSD material 405 may be provided as a trace element on a surface of the substrate 410 to protect against voltage conditions that arise from a battery event. Any composition of VSD material in accordance with embodiments described herein may be implemented for use as VSD material for device and device configurations described in U.S. patent application Ser. No. 11/562,222 (incorporated by reference herein), which describes numerous implementations of wireless communication devices which incorporate VSD material.

As an alternative or variation, the component 420 may correspond to, for example, a discrete semiconductor device. The VSD material 405 may be integrated with the component, or positioned to electrically couple to the component in the presence of a voltage that switches the material on.

Still further, device 400 may correspond to a packaged device, or alternatively, a semiconductor package for receiving a substrate component. VSD material 405 may be combined with the casing 430 prior to substrate 410 or component 420 being included in the device.

Embodiments described with reference to the drawings are considered illustrative, and Applicant's claims should not be limited to details of such illustrative embodiments. Various modifications and variations will may be included with embodiments described, including the combination of features described separately with different illustrative embodiments. Accordingly, it is intended that the scope of the invention be defined by the following claims. Furthermore, it is contemplated that a particular feature described either individually or as part of an embodiment can be combined with other individually described features, or parts of other embodiments, even if the other features and embodiments make no mentioned of the particular feature.

What is claimed:

1. A composition of voltage switchable dielectric material comprising a polymer binder comprising a mixture of two or more types of polymers or copolymers, wherein an effective band gap of the polymer binder is less than 2 eV.

2. The composition of claim 1, wherein at least one type of polymer in the polymer binder has a band gap that is sufficiently low to enable the effective band gap of the polymer binder to be less than 2 eV.

3. The composition of claim 1, wherein at least another type of polymer in the polymer binder is epoxy.

4. A composition comprising:
a polymer binder that has an effective band gap of less than 2 eV;
one or more classes of particle constituents, including a class of semiconductive particles that individually have a band gap that is less than 2 eV;
wherein said composition is (i) dielectric in absence of a voltage that exceeds a characteristic voltage level, and (ii) conductive with application of said voltage that exceeds the characteristic voltage level.

5. The composition of claim 4, wherein the semiconductive particles are micron or nanometer in dimension.

6. The composition of claim 4, wherein the band gap of the individual semiconductive particles is substantially equal to or less than the band gap of the polymer binder.

7. The composition of claim 4, wherein the one or more classes of particle constituents include conductive particles.

8. The composition of claim 4, wherein the one or more classes of particle constituents include high aspect ratio particles other than the class of semiconductive particles with the band gap of less than 2 eV.

9. The composition of claim 4, wherein the semiconductive particles include or correspond to compound semiconductors of a class III-V, II-VI, III-VI, and I-III-VI.

10. The composition of claim 9, wherein the compound semiconductors are high aspect ratio particles.

11. The composition of claim 9, wherein the compound semiconductor includes at least some concentration of Quantum Dot particles.

12. The composition of claim 9, wherein the semiconductor includes at least some concentration of nano-sized crystalline silicon.

13. The composition of claim 4, wherein the polymer corresponds to epoxy or acrylate.

14. The composition of claim 4, wherein the polymer binder includes a blend of polymers that includes at least one polymer with band gap that is sufficiently low to enable the effective band gap of the blend to be less than 2 eV.

15. A device comprising:
a protective layer of voltage switchable dielectric (VSD) material comprising:
a polymer binder;
a concentration of semiconductive particles dispersed in the polymer that individually have a band gap that is substantially equal to or less than a band gap of the polymer binder.

16. The device of claim 15, wherein the concentration of semiconductive particles are micron or nanometer in dimension.

17. The device of claim 16, wherein the VSD material further comprises, in addition to the concentration of semiconductive particles, a concentration of one or more classes of particles corresponding to conductive particles, higher band gap semiconductive particles, or high aspect ratio particles.

18. The device of claim 15, wherein the semiconductive particles with the band gap of less than 2 eV include or correspond to compound semiconductors of a class III-V, II-VI, III-VI, and I-III-VI.

19. The device of claim 15, wherein the semiconductor particles with the band gap of less than 2 eV includes at least some concentration of Quantum Dot particles.

20. The device of claim 15, wherein the semiconductor particles with the band gap of less than 2 eV includes at least some concentration of nanometer dimensioned crystalline silicon.
